(19) United States
(12) Patent Application Publication
(10) Pub. No.: US 2015/0364772 A1
(43) Pub. Date: Dec. 17, 2015

(54) METHOD TO PREPARE ALLOYS OF PLATINUM-GROUP METALS AND EARLY TRANSITION METALS

(71) Applicant: GM GLOBAL TECHNOLOGY OPERATIONS LLC, Detroit, MI (US)

(72) Inventor: ANUSORN KONGKANAND, ROCHESTER HILLS, MI (US)

(21) Appl. No.: 14/713,685

(22) Filed: May 15, 2015

Related U.S. Application Data
(60) Provisional application No. 62/005,410, filed on May 30, 2014.

(51) Int. Cl. H01M 4/92; H01M 4/88

(52) U.S. Cl. CPC H01M 4/925; H01M 4/921; H01M 4/8803; H01M 4/8817; H01M 4/8867

(57) ABSTRACT

A method for making platinum group metal (PGM) alloys for fuel cell applications includes a step of heating a substrate to a predetermined temperature. The substrate is contacted with a vapor of a PGM-containing compound and then with a vapor of an early transition metal-containing compound. These contacting steps are repeated a plurality of times to form a PGM alloy layer on the carbon particles. The present method allows the PGM alloy layer to be built up monolayer-by-monolayer thereby providing for uniform coating on a support with high porosity or complex morphology. Advantageously, the present embodiment provides a method for preparing a catalyst with higher activity and durability than current alloy catalysts.

### CROSS-REFERENCE TO RELATED APPLICATIONS

This application claims the benefit of U.S. provisional application No. 62/005,410 filed May 30, 2014, the disclosure of which is incorporated herewith in its entirety by reference herein.

### TECHNICAL FIELD

In at least one aspect, the present rejection is related to corrosion resistant carbon supports for fuel cell and battery applications.

### BACKGROUND

Fuel cells are used as an electrical power source in many applications. In particular, fuel cells are proposed for use in automobiles to replace internal combustion engines. A commonly used fuel cell design uses a solid polymer electrolyte (“SPE”) membrane or proton exchange membrane (“PEM”) to provide ion transport between the anode and cathode.

In proton exchange membrane type fuel cells, hydrogen is supplied to the anode as fuel and oxygen is supplied to the cathode as the oxidant. The oxygen can either be in pure form (O₂) or air (a mixture of O₂ and N₂). PEM fuel cells typically have a membrane electrode assembly (“MEA”) in which a solid polymer membrane has an anode catalyst on one face, and a cathode catalyst on the opposite face. The anode and cathode layers of a typical PEM fuel cell are formed of porous conductive materials, such as woven graphite, graphitized sheets, or carbon paper to enable the fuel and oxidant to disperse over the surface of the membrane facing the fuel- and oxidant-supply electrodes, respectively. Each electrode has finely divided catalyst particles (for example, platinum particles) supported on carbon particles to promote oxidation of hydrogen at the anode and reduction of oxygen at the cathode. Protons flow from the anode through the ionically conductive polymer membrane to the cathode where they combine with oxygen to form water which is discharged from the cell. The MEA is sandwiched between a pair of porous gas diffusion layers (“GDL”) which, in turn, are sandwiched between a pair of non-porous, electrically conductive elements or plates. The plates function as current collectors for the anode and the cathode, and contain appropriate channels and openings formed therein for distributing the fuel cell's gaseous reactants over the surface of respective anode and cathode catalysts. In order to produce electricity efficiently, the polymer electrolyte membrane of a PEM fuel cell must be thin, chemically stable, proton transmissive, non-electrically conductive and gas impermeable. In typical applications, fuel cells are provided in arrays of many individual fuel cell stacks in order to provide high levels of electrical power.

Alloying of Pt with transition metals (Co, Ni, etc.) is commonly attempted to increase the activity of the catalyst but the stability of these metals leads to losses of activity and performance. Accordingly, there is a need for improved methodology for making carbon supported electrocatalysts for fuel cell applications. Theoretical and experimental studies suggest both high activity and stability in alloys of Pt and early transition metals, more specifically yttrium and scandium. However, the high affinity of oxygen of these elements makes it very difficult to form small dispersed particles or sufficiently thin film to make the catalyst economically viable. Very high temperature which causes particle growth also is required to prepare these alloys. To our knowledge, successful preparation has only been achieved with a sputtering method which is not a controllable means to form nanoparticles.

Accordingly, there is a need for improved methods of forming catalysts for fuel cells with higher catalytic activity than currently available.

### SUMMARY

The present invention solves one or more problems of the prior art by providing in at least one embodiment, a method for making platinum alloys for fuel cell applications. The method includes a step of heating a substrate to a predetermined temperature. The substrate is contacted with a vapor of a platinum group metal (PGM) containing compound to form a layer of PGM-containing compound precursors disposed over the substrate. The substrate is also contacted with a vapor of an early transition metal-containing compound to form a layer of early transition metal-containing precursors disposed over the substrate. The layer of PGM-containing compound residues and the layer of early transition metal-containing precursors are contacted with a hydrogen plasma to form a monolayer of PGM alloy. The steps of contacting the substrate with the PGM-containing compound and the early transition metal compound, and the hydrogen plasma are repeated a plurality of times to form a platinum alloy layer of predetermined thickness on the substrate.

### BRIEF DESCRIPTION OF THE DRAWINGS

FIG. 1 is a cross sectional view of a fuel cell incorporating a substrate coated with a platinum alloy layer;

FIG. 2 provides a schematic flowchart illustrating a method for making a substrate coated with a platinum alloy layer;

FIG. 3 provides a schematic flowchart illustrating a method for making a substrate coated with a platinum alloy layer;

FIG. 4 provides a schematic flowchart illustrating a method for making a substrate coated with a platinum alloy layer; and

FIG. 5 is a schematic diagram of an atomic layer deposition system.

### DETAILED DESCRIPTION

Reference will now be made in detail to presently preferred compositions, embodiments and methods of the present invention which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

The term “residue” as used in at least one embodiment refers to that portion of a chemical compound that remains on a substrate after the substrate is contacted with the chemical compound.

### Abbreviations:

“ALD” refers to atomic layer deposition.

“NSTF” refers to nanostructured thin film.

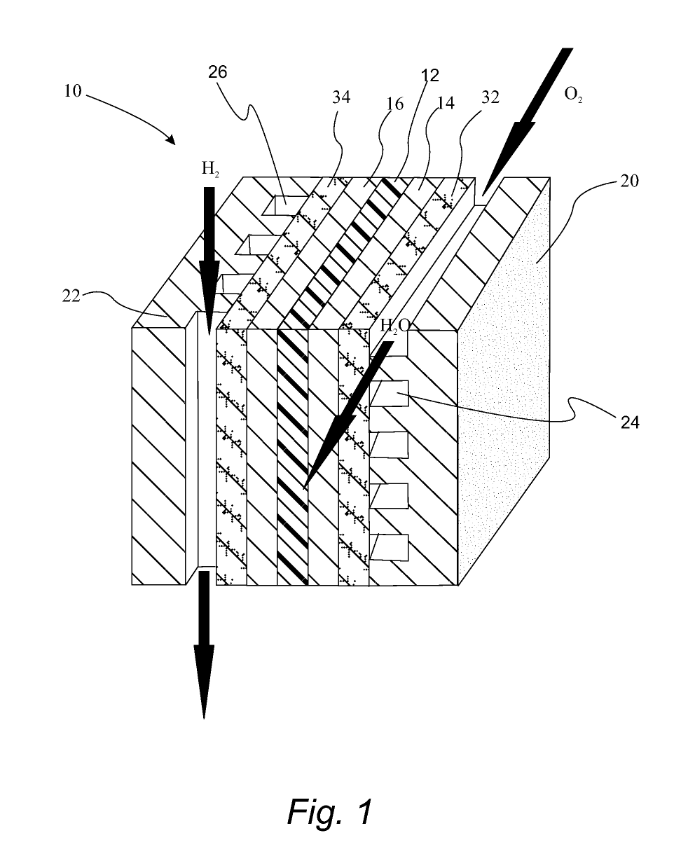

With reference to FIG. 1, a cross sectional view of a fuel cell incorporating the corrosion resistant substrate set forth above is provided. PEM fuel cell 10 includes polymeric ion conducting membrane 12 disposed between cathode electro-catalyst layer 14 and anode electro-catalyst layer 16. Fuel cell 10 also includes electrically conductive flow field plates 20, 22 which include gas channels 24 and 26. Flow field plates 20, 22 are either bipolar plates (illustrated) or unipolar plates (i.e., end plates). In a refinement, flow field plates 20, 22 are formed from a metal plate (e.g., stainless steel) optionally coated with a precious metal such as gold or platinum. In another refinement, flow field plates 20, 22 are formed from conducting polymers which also are optionally coated with a precious metal. Gas diffusion layers 32 and 34 are also interposed between flow field plates and a catalyst layer. Cathode electro-catalyst layer 14 and anode electro-catalyst layer 16 include catalytic platinum alloys made by the processes set forth below. Advantageously, the platinum alloys enhance the activity of the oxygen reduction reaction when incorporated into cathode electro-catalyst layers.

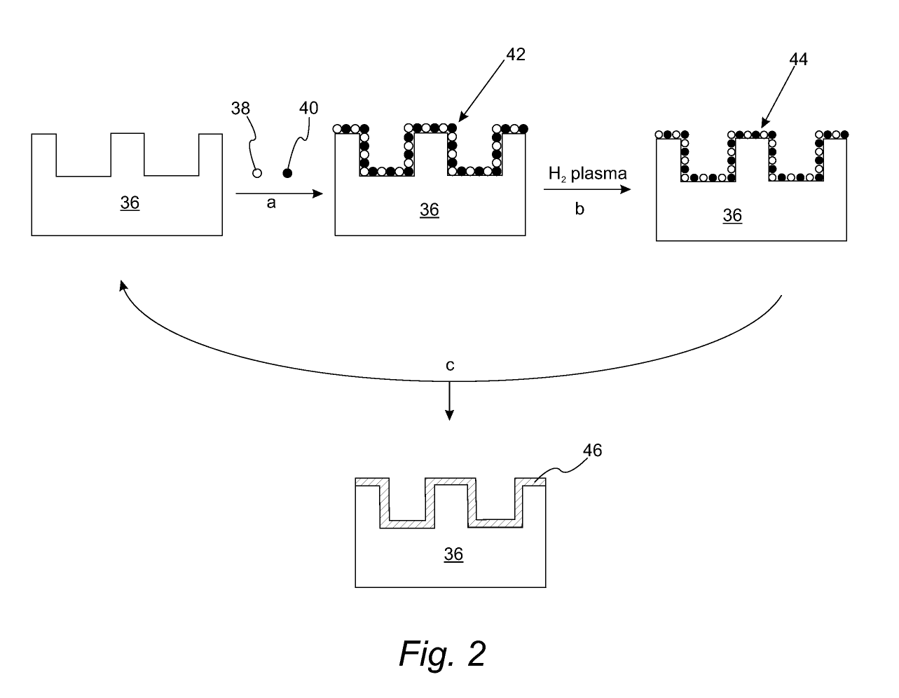

With reference to FIG. 2, a method for making platinum alloy catalysts for fuel cells is provided. The method includes step a) in which substrate 36 is contacted with a vapor of a platinum group metal-containing compound 38 and an early transition metal-containing compound 40 to form precursor layer 42. Typically, PGM containing compounds include Pt, Pd, Au, Ru, Ir, Rh, or Os. Typically, early transition metal-containing compounds include Sc, Ti, V, Cr, Mn, Y, Zr, Nb, Mo, Tc, La, Hf, Ta, W, or Re. In a refinement, early transition metal-containing compounds include Sc, Ti, Y, or Zr. Yttrium-containing and scandium-containing compounds are particularly useful. An example of a platinum-containing compound includes, but is not limited to, trimethyl(methylcyclopentadienyl)platinum. Examples of yttrium-containing compounds include, but are not limited to, tris(methylcyclopentadienyl)yttrium and tris[N,N-bis(trimethylsilyl)amide]yttrium. Examples of scandium-containing compounds include, but are not limited to, tris(methylcyclopentadienyl)scandium, tris(cyclopentadienyl)scandium, tris[N,N-(diisopropyl)acetamidinate)scandium, and Sc(2,2,6,6-tetramethyl-3,5-heptanedione). Although virtually any substrate can be used in practicing the method of the present embodiment, suitable examples include TiO₂ supports, and NSTF supports, other metal oxide supports, metal carbide supports, carbon black supports, carbon nanotube supports. In a refinement, the support includes carbon particles having an average spatial dimension from about 10 to 100 nanometers. In step b), precursor layer 42 is contacted with a hydrogen plasma to form a platinum group metal alloy layer 44. These contacting steps are repeated a plurality of times to form a platinum group metal alloy layer 46 of predetermined thickness on (e.g., contacting the surface of) the substrate 36 as indicated by loop c). In a variation, the contacting steps are repeated from 1 to several thousand deposition cycles depending on the desired thickness of a platinum group metal alloy layer 44. In a refinement, the contacting steps are repeated for 1 to 5000 deposition cycles. In another refinement, the contacting steps are repeated for 10 to 2000 deposition cycles. In still another refinement, the contacting steps are repeated for 20 to 1000 deposition cycles

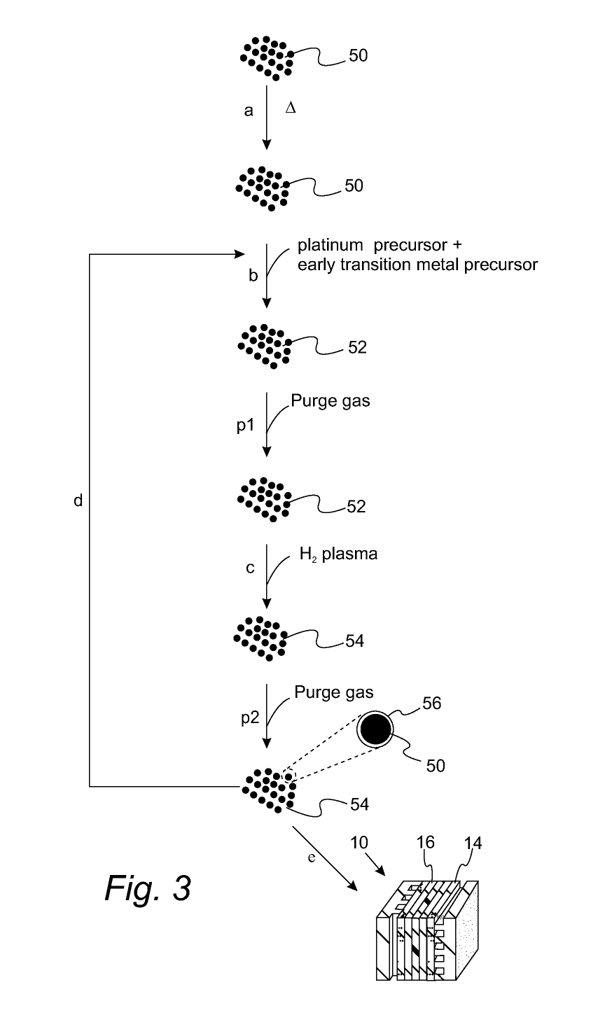

With reference to FIG. 3, a method for making a platinum group metal alloy catalyst by atomic layer deposition (ALD) is provided. In step a), substrates 50 are heated to a predetermined temperature in an ALD reactor. In a refinement, substrates 50 are heated to a temperature from about 80° C. to 150° C. Examples of suitable substrates are set forth above. In step b), the substrates 50 are contacted with a vapor of a platinum group metal-containing compound and an early transition metal-containing compound in the reactor to form substrates 52 in which a layer including residues of the platinum group metal-containing compound and early transition metal-containing compound is individually disposed over substrates 50. Suitable platinum group metal-containing compounds and early transition metal-containing compounds are set forth above. In step p1), the reactor is evacuated and/or substrates 52 are purged with an inert gas (e.g., nitrogen, helium, argon, and the like) by purging the ALD reactor. In step c), substrates 52 are contacted with a H₂ plasma to form a monolayer of a platinum group metal alloy disposed over substrates 50 (item number 54 refers to the coated substrates formed in this step). In step p2), the reactor is evacuated and/or substrates 54 are purged with an inert gas (e.g., nitrogen, helium, argon, and the like).

Still referring to FIG. 3, as illustrated by loop d, steps b, p1, c, p2 are repeated a plurality of times to form a platinum group metal alloy layer 56 of predetermined thickness on substrate 50. In a refinement, these steps are repeated 1 to 1000 times to build up the thickness of the platinum group metal alloy layer 56 monolayer by monolayer until a desired thickness is achieved. In a refinement, the thickness of the platinum group metal alloy layer 56 is from 0.2 nanometer to 30 nanometers. In another refinement, the thickness of the platinum group metal alloy layer 56 is from 0.2 nanometers to 4 nanometers. In step e), platinum group metal alloy coated substrates 50 are incorporated into cathode catalyst layer 14 and/or anode catalyst layer 16 of fuel cell 10.

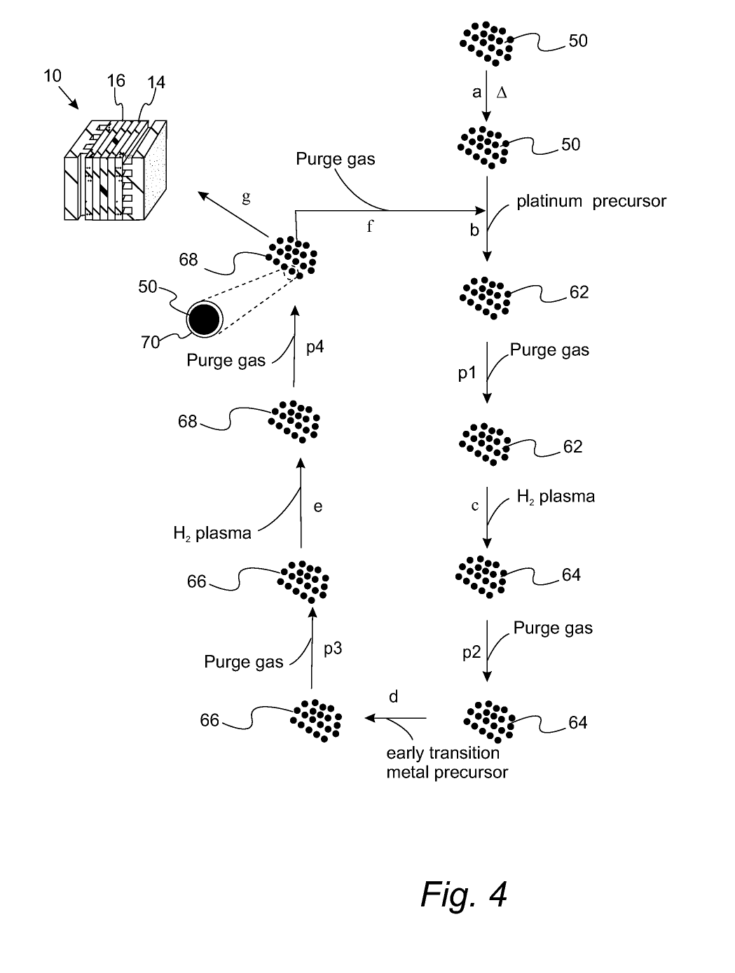

With reference to FIG. 4, a method for making a platinum group metal alloy catalyst by atomic layer deposition (ALD) is provided. In step a), substrates 50 are heated to a predetermined temperature in an atomic layer deposition reactor. In a refinement, substrates 50 are heated to a temperature from about 80° C. to 150° C. Examples for substrates 50 are set forth above. In step b), substrates 50 are contacted with a vapor of a platinum group metal-containing compound to form substrates 62 in which a layer of platinum group metal-containing compound residues are disposed over substrates 50. Suitable platinum group metal-containing compounds are set forth above. In step p1), the reactor is evacuated and/or substrates 62 are purged with an inert gas (e.g., nitrogen, helium, argon, and the like). In step c), substrates 62 are contacted with a hydrogen plasma to form substrates 64 in which the residues of the platinum group metal-containing compound have been converted to platinum group metal. In step p2), the reactor is evacuated and/or substrates 64 are purged with an inert gas (e.g., nitrogen, helium, argon, and the like). In step d), substrates 64 are contacted with a vapor of an early transition metal-containing compound to form substrates 66 in which a layer of residues of the early transition metal-containing compound are disposed over substrates 50. In step p3), the reactor is evacuated and/or substrates 66 are purged with an inert gas (e.g., nitrogen, helium, argon, and the like). In step e), substrates 66 are contacted with a hydrogen plasma to form substrates 68 in which the residues of the early transition metal-containing compound have been converted to a monolayer of early transition metal. In step p4), the reactor is evacuated and/or substrates 68 are purged with an inert gas (e.g., nitrogen, helium, argon, and the like).

Still referring to FIG. 4, as illustrated by loop f, steps b, p1, c, p2, d, p3, e, and p4 are repeated a plurality of times to form a platinum group metal alloy layer 70 of predetermined thickness disposed over substrates 50. In a refinement, these steps are repeated 1 to 1000 times to build up the thickness of the platinum group metal alloy layer 56 monolayer by monolayer until a desired thickness is achieved. In a refinement, the thickness of the platinum group metal alloy layer 56 is from 0.2 nanometers to 30 nanometers. In another refinement, the thickness of the platinum group metal alloy layer 56 is from 0.2 nanometers to 4 nanometers. In step g), platinum group metal alloy coated substrates 50 are incorporated into cathode catalyst layer 14 and/or anode catalyst layer 16 of fuel cell 10.

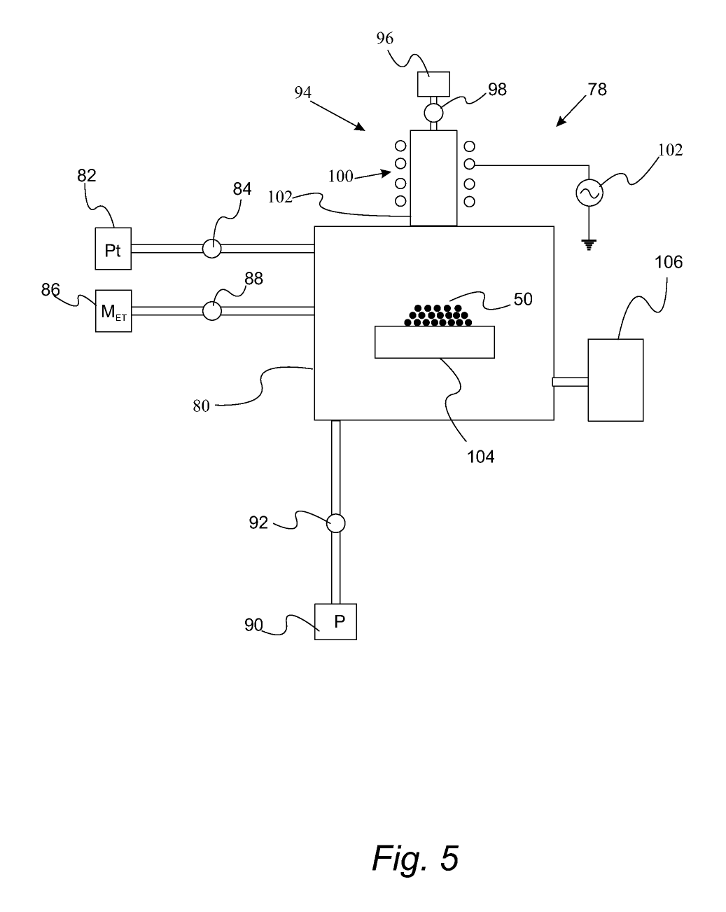

With reference to FIG. 5, a schematic illustration of an atom layer deposition apparatus for implementing the methods set forth above is provided. Reactor 78 includes vacuum chamber 80 which has platinum group metal-containing compound source 82 with associated pulse valve 84, early transition metal-containing compound source 86 with associated pulse valve 88, and purge gas source 90 with associated pulse valve 92. Reactor 80 also includes hydrogen plasma source 94 which has hydrogen gas source 96, associated pulse valve 98, and RF coils 100 with associated power supply 102. The RF coils induce the H₂ plasma formation as hydrogen-containing gas flows through conduit 102. In each case, the respective gaseous reactant is introduced by opening of the pulse valve for a predetermined pulse time. Similarly, for purging steps the inert gas is introduced by opening of pulse valve 92 for a predetermined purge time. In one refinement, pulse times and purge times are each independently from about 0.0001 to 200 seconds. In another refinement, pulse and purge times are each independently from about 0.1 to about 10 seconds.

During coating, the substrates 50 are heated via heater 104 to a temperature suitable to the properties of the chemical precursor(s) and coatings to be formed. In another refinement of the method, the substrate has a temperature from about 80 to 150° C. Similarly, the pressure during film formation is set at a value suitable to the properties of the chemical precursors and coatings to be formed. Vacuum system 106 is used to establish the reactor pressure and remove the reagents and purge gas. In one refinement, the pressure is from about 10⁻⁶ Torr to about 760 Torr. In another refinement, the pressure is from about 0.1 millitorr to about 10 Torr. In still another refinement, the pressure is from about 1 to about 5 Torr.

The following examples illustrate the various embodiments of the present invention. Those skilled in the art will recognize many variations that are within the spirit of the present invention and scope of the claims.

A 3M NSTF support is used as a catalyst as a substrate. The NSTF support is a highly-oriented laft-shape substrate made from a self-assembly of an organic compound, perylene red dye. Its high length-to-width aspect ratio of about 15 makes it very difficult to be coated with any metal and especially a high-surface-energy metal such as platinum. It is noted that large amounts of platinum are wasted at the substrate tip when the deposition of platinum alloy is performed with conventional sputtering methods. A 2 nm thick tungsten layer is first deposited by alternating 14 cycles of WF₆ (as W precursor) and Si₂H₆ (as a reactant). Pt and early transition metals are co-deposited or alternatively-deposited onto the adhesive layer using H₂ plasma. Therefore, 150 cycles of Pt and Y ALD at 120° C. and 100 watts H₂ plasma yield about 3 nm thick film. Examples of the metal precursors include trimethyl(methylcyclopentadienyl)platinum, tris(methylcyclopentadienyl)yttrium, tris [N,N-bis(trimethylsilyl)amide]yttrium, tris(methylcyclopentadienyl)scandium, tris(cyclopentadienyl)scandium, tris[N,N-(diisopropyl)acetamidinate)scandium, and Sc(2,2,6,6-tetramethyl-3,5-heptanedione).

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method comprising:
a) heating a substrate to a predetermined temperature;
b) contacting the substrate with a vapor of a platinum group metal-containing compound to form a layer of platinum group metal-containing compound residues disposed over the substrate;
c) contacting the substrate with a vapor of an early transition metal-containing compound to form a layer of early transition metal-containing residues disposed over the substrate;
d) contacting the layer of platinum group metal-containing compound residues and the layer of early transition metal-containing residues with a hydrogen plasma to form a monolayer of platinum group metal alloy; and
e) repeating steps b) and c) a plurality of times to form a platinum group metal alloy layer on the substrate.

2. The method of claim 1 wherein the substrate is simultaneously contacted with the vapor of a platinum group metal-containing compound and the vapor of an early transition metal-containing compound.

3. The method of claim 1 wherein the substrate is alternately contacted with the vapor of a platinum group metal-containing compound and the vapor of an early transition metal-containing compound.

4. The method of claim 1 wherein the early transition metal-containing compound includes Sc, Ti, V, Cr, Mn, Y, Zr, Nb, Mo, Tc, La, Hf, Ta, W, or Re.

5. The method of claim 1 wherein the early transition metal-containing compound includes Sc, Ti, Y, or Zr.

6. The method of claim 1 wherein the early transition metal-containing compound is a yttrium-containing compound or a scandium-containing compound.

7. The method of claim 6 wherein the platinum group metal-containing compound is trimethyl(methylcyclopentadienyl)platinum.

8. The method of claim 6 wherein the yttrium-containing compound is tris(methylcyclopentadienyl)yttrium or tris[N,N-bis(trimethylsilyl)amide]yttrium and the scandium-containing compound is tris(methylcyclopentadienyl)scandium, tris(cyclopentadienyl)scandium, tris[N,N-(diisopropyl)acetamidinate)scandium, or Sc(2,2,6,6-tetramethyl-3,5-heptanedione).

9. The method of claim 1 wherein the platinum group metal-containing compound includes Pt, Pd, Au, Ru, Ir, or Rh.

10. The method of claim 1 wherein the substrate includes a component selected from the group consisting of TiO₂ supports, NSTF supports, other metal oxide supports, metal carbide supports, carbon black supports, and carbon nanotube supports.

11. A method comprising:
a) heating a substrate to a predetermined temperature, wherein the substrate includes a component selected from the group consisting of TiO₂ supports, NSTF supports, other metal oxide supports, metal carbide supports, carbon black supports, and carbon nanotube supports;
contacting the substrate with a vapor of a platinum group metal-containing compound to form a layer of platinum group metal-containing compound residues disposed over the substrate;
b) contacting the substrate with a vapor of an early transition metal-containing compound to form a layer of early transition metal-containing residues disposed over the substrate;
c) contacting the layer of platinum group metal-containing compound residues and the layer of early transition metal-containing residues with a hydrogen plasma to form a monolayer of platinum group metal alloy wherein the early transition metal-containing compound includes Sc, Ti, Y, or Zr; and
d) repeating steps b) and c) a plurality of times to form a platinum group metal alloy layer on the substrate.

12. The method of claim 11 wherein the substrate is simultaneously contacted with the vapor of a platinum group metal-containing compound and the vapor of an early transition metal-containing compound.

13. The method of claim 11 wherein the substrate is alternately contacted with the vapor of a platinum group metal-containing compound and the vapor of an early transition metal-containing compound.

14. The method of claim 11 wherein the early transition metal-containing compound includes Sc, Ti, V, Cr, Mn, Y, Zr, Nb, Mo, Tc, La, Hf, Ta, W, or Re.

15. The method of claim 11 wherein the early transition metal-containing compound is a yttrium-containing compound or a scandium-containing compound.

16. The method of claim 15 wherein the platinum group metal-containing compound is trimethyl(methylcyclopentadienyl)platinum.

17. The method of claim 15 wherein the yttrium-containing compound is tris(methylcyclopentadienyl)yttrium or tris[N,N-bis(trimethylsilyl)amide]yttrium.

18. The method of claim 15 wherein the scandium-containing compound is tris(methylcyclopentadienyl)scandium, tris(cyclopentadienyl)scandium, tris[N,N-(diisopropyl)acetamidinate)scandium, or Sc(2,2,6,6-tetramethyl-3,5-heptanedione).

19. The method of claim 11 wherein the platinum group metal-containing compound includes Pt, Pd, Au, Ru, Ir, or Rh.

20. The method of claim 11 wherein the substrate is a NSTF support, a carbon black support, or a carbon nanotube support.
